(19) United States
(12) Patent Application Publication
(10) Pub. No.: US 2006/0160658 A1
(43) Pub. Date: Jul. 20, 2006

(54) Method and apparatus for determining a slippage setting between two components that transmit force through frictional engagement

(75) Inventor: Michael Reuschel, Ottersweier (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/303,871

(22) Filed: Dec. 17, 2005

(30) Foreign Application Priority Data
Dec. 18, 2004 (DE) 10 2004 060 989.6

(51) Int. Cl. F16H 61/662

(52) U.S. Cl. 477/44

(57) ABSTRACT

A method and apparatus for determining a slippage setting between two components that transmit force through frictional engagement. One component is driven by a drive unit and the other component is an output member for driving a driven unit. A contact force that brings about the frictional connection between the components is variable. The method includes determining at least one operating parameter of at least the drive unit or of the driven unit, and establishing a desired slippage value setting corresponding to the desired slippage setting that is determined from a predetermined relationship between at least one operating parameter and the slippage value.

### BACKGROUND OF THE INVENTION

1. Field of the Invention

The invention concerns a method and apparatus for determining a slippage setting between two components that transmit force through frictional engagement.

2. Description of the Related Art

For reasons of convenience, fuel consumption, and environmental concerns, automated power trains are increasingly being used in motor vehicles. Such power trains contain, for example, a belt-driven conical disk pair transmission with a continuously variable transmission ratio.

A continuously variable transmission is shown schematically in FIG. 3. An input shaft 6 is driven by an internal combustion engine 4. A clutch (not shown), preferably an automated clutch, and a reversible-direction transmission are positioned between the engine and input shaft. Input shaft 6 is rigidly connected to one conical disk 8 of an input-side conical disk pair SS1. Another conical disk 10 is positioned on input shaft 6 so that it is rotationally fixed and axially movable. Between conical disk 10 and a supporting component that is rigidly connected to input shaft 6, pressure chambers are formed, by which, when they are pressurized, it is possible to change the force with which conical disk 10 can be pressed in the direction of conical disk 8.

In a similar manner, an output side conical disk pair SS2 includes a conical disk 14 that is rigidly connected to a take-off or output shaft 12, and an axially movable conical disk 16 that can be forced in the direction of conical disk 14 by pressurizing associated pressure chambers. Between the two disk pairs SS1 and SS2 an endless torque-transmitting means 18 circulates, for example a link chain.

The contact force with which endless torque-transmitting means 18 contacts the conical surfaces of the conical disks in frictional engagement is controlled by means of hydraulic valves 20, 22, 24. Hydraulic valve 20, for example, determines in a known way a basic contact force that depends on the torque acting on the input shaft, and the shifting of the transmission ratio is accomplished with hydraulic valves 22 and 24. The pressure medium for the valves 20, 22, and 24 is supplied from a hydraulic pump 26.

Valves 20, 22, 24 are controlled by an electronic control unit 28, at the inputs of which there are signals from a rotational speed sensor 30, for ascertaining the rotational speed of the input shaft 6, from a rotational speed sensor 32, for ascertaining the rotational speed of the output shaft 12, and additional signals that contain essential information for controlling the valves, for example the output signal of a position sensor 34 for detecting the position of an accelerator or gas pedal 36. Advantageously, control unit 28 communicates via a bus conduit 38 with other control units or electronic devices of the vehicle, so that for example the vehicle speed, a particular driving program, the presence of a driving stability system, the momentary transmission ratio of the transmission, etc., are known in the control unit 28. Those signals and that information are converted to control signals for the valves in accordance with the programs stored in control unit 28. Other outputs of control unit 28 can control an automated clutch, for example.

The construction and function of the above-described power train are known, and therefore are not described in further detail.

Suitable contact force between endless torque-transmitting means 18 and conical disk pairs SS1 and SS2 is decisive for prolonged, reliable operation of the endless torque-transmitting means. That contact force must be such that the endless torque-transmitting means on the one hand does not slip, i.e., does not slip more than permitted, and on the other hand must not be clamped with unnecessarily high pressure, so that the components are less loaded and the transmission operates efficiently.

Direct determination of the slippage between the endless torque- transmitting means and the pairs of conical disks is relatively complex, since that requires that the speed of circulation of endless torque-transmitting means 18 and the respective operating radii of the pairs of conical disks be determined. There are various ways for determining the momentary slippage, or a slippage variable that characterizes it. In those methods, for example, the contact force of at least one pair of conical disks is modulated with a frequency that is greater than the transmission ratio adjustment frequency of the transmission, and the changes in the rotational speeds of the input shaft and the output shaft in response to the pressure modulation are detected. Those changes are merely due to the changes in the momentary slippage of the transmission, and can be drawn upon to produce the slippage by taking the absolute value and the mean value.

The operating condition of the components that transmit force through frictional engagement can only be evaluated meaningfully on the basis of the measured slippage if it can be compared with a desired value for the slippage or slippage setting that is suitable for the components that transmit force through frictional engagement. Suitable means an operating condition in a belt-driven conical-pulley transmission that does not result in excessive contact forces, which would produce increased wear or an increase in the torque losses of the respective components.

An object of the invention is to provide a method and apparatus with which the particular slippage setting can be practically determined.

### SUMMARY OF THE INVENTION

The method aspect of the object of the invention is achieved with a method for determining a slippage setting between two components that transmit force through frictional engagement. One of the components is driven by a drive unit and the other forms an output member for driving a driven unit, wherein a contact force that brings about the frictional connection between the components is variable. The method includes the following steps: determining at least one operating parameter of at least the drive unit or of the driven unit, and establishing a value for the slippage setting corresponding to the slippage setting that is to be determined from a certain relationship between the at least one operating parameter and the slippage value.

With the method in accordance with the invention, the slippage setting can be adapted to particular operating parameters, so that demands on the one hand of avoiding unnecessarily high contact pressures between the parts that are transmitting force through frictional engagement, and on the other hand of providing good comfort by avoiding unacceptably low contact forces between the components that transmit force, can be taken into account.

Advantageously, the slippage value setting is reduced while the drive power delivered by the drive unit and/or the delivered drive torque is increased.

Also preferred is setting the slippage value so that a predetermined maximum friction loss caused by slippage is not exceeded. In that way it is possible to ensure that unacceptably high temperatures do not occur at the surfaces that are frictionally engaged.

Furthermore, the slippage value setting is advantageously determined so that the friction loss produced is not less than a minimum caused by the slippage. That ensures that excessively high contact pressure does not occur.

Preferably, the method in accordance with the invention is carried out in such a way that the driven component is the input-side disk pair of a belt-driven conical-pulley transmission contained in a power train of a motor vehicle, and the other component is the disk pair on the output side, and the slippage value setting is lowered when the drive torque of the input-side disk pair is high and the travel speed is low, or at an underdrive transmission ratio or in decelerating.

Also preferred is an implementation of the method in accordance with the invention such that the driven component is the input-side disk pair of a belt-driven conical-pulley transmission contained in a power train of a motor vehicle, and the other component is the disk pair on the output side, and the slippage value setting is raised in the region of medium speeds and low to medium drive torques.

Also preferred is an implementation of the method in accordance with the invention such that the driven component is the input-side disk pair of a belt-driven conical-pulley transmission contained in a power train of a motor vehicle, and the other component is the disk pair on the output side, and the slippage value setting is reduced when operating parameters change suddenly, such as a sudden activation of the accelerator or the engagement of an ESP (electronic stability program) system.

In an implementation of the method in accordance with the invention in which the driven component is the input-side disk pair of a belt-driven conical-pulley transmission contained in a power train of a motor vehicle, and the other component is the disk pair on the output side, the slippage value setting is determined in accordance with the following relationship:
SS=GS−d(Mmf/dt)*Factor−f(iᵥₐᵣ),

where

SS=the slippage value setting,

GS=a predetermined basic slippage value, which can be a function of operating parameters,

Mmf=the filtered torque of an engine that drives the input-side disk pair, Factor=a proportionality factor, and

F(iᵥₐᵣ)=the function of the transmission ratio iᵥₐᵣ.

A refinement of the method in accordance with the invention for regulating the actual slippage value is distinguished by the fact that the actual slippage value is determined, and the contact forces that bring about the frictional engagement are changed in such a way that the difference between the slippage value setting and the actual slippage value decreases.

Apparatus for determining the setting for slippage between two components that transmit force though frictional engagement, one of which is driven by a drive device and the other is an output for driving a driven apparatus, advantageously contains a determination unit for determining at least one operating parameter of at least the drive unit or the driven unit, a contact pressure unit for applying to the components a variable contact pressure that brings about the frictional engagement, and a desired slippage value determination unit for determining the slippage value setting as a function of at least one operating parameter.

The desired slippage value determination unit contains, for example, a characteristic curve that specifies the slippage value setting as a function of the at least one operating parameter.

Furthermore, the apparatus in accordance with the invention advantageously includes an actual slippage value determination unit for determining the actual slippage value, and a control unit for actuating the contact pressure unit in such away that a difference between the actual slippage value and the desired slippage value decreases.

The invention, which can be used with practically all types of components that transmit power or torque through frictional engagement, is preferably used for friction clutches and transmissions having a continuously variable transmission ratio.

### BRIEF DESCRIPTION OF THE DRAWINGS

The structure, operation, and advantages of the present invention will become further apparent upon consideration of the following description, taken in conjunction with the accompanying drawings in which:

FIGS 1a and 1b show curves to explain the determination of the slippage setting in the event of a sudden increase in the torque acting on the input side of a belt-driven conical-pulley transmission;

FIGS. 2a, 2b, and 2c show curves to explain the determination of a slippage setting during underdrive of a belt-driven conical-pulley transmission; and

FIG. 3 is a schematic diagram of a belt-driven conical-pulley transmission with pressure supply and control unit and contained in a known power train.

### DESCRIPTION OF THE PREFERRED EMBODIMENTS

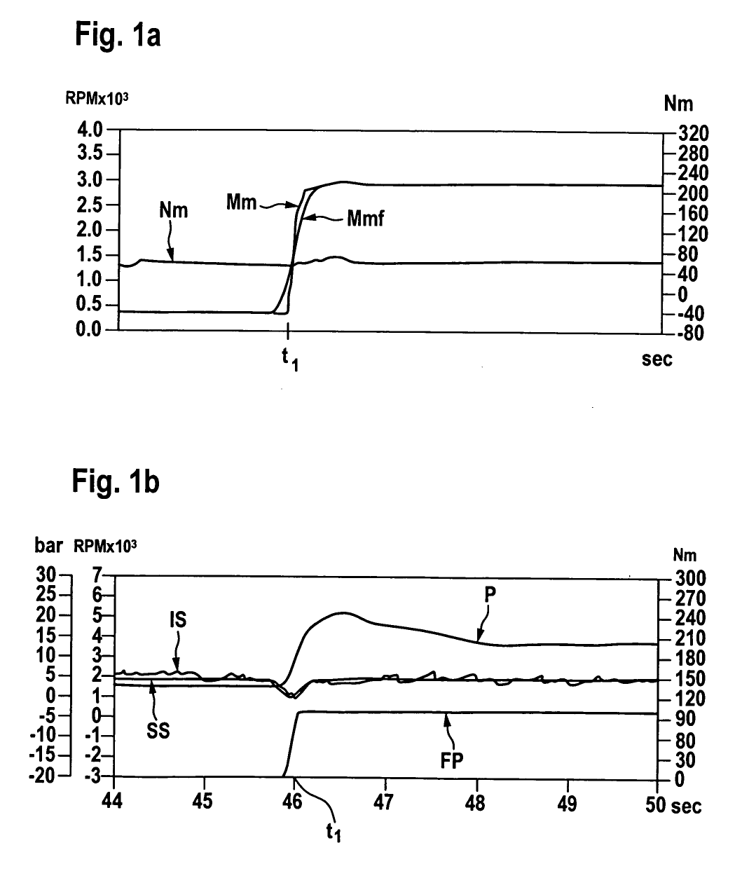

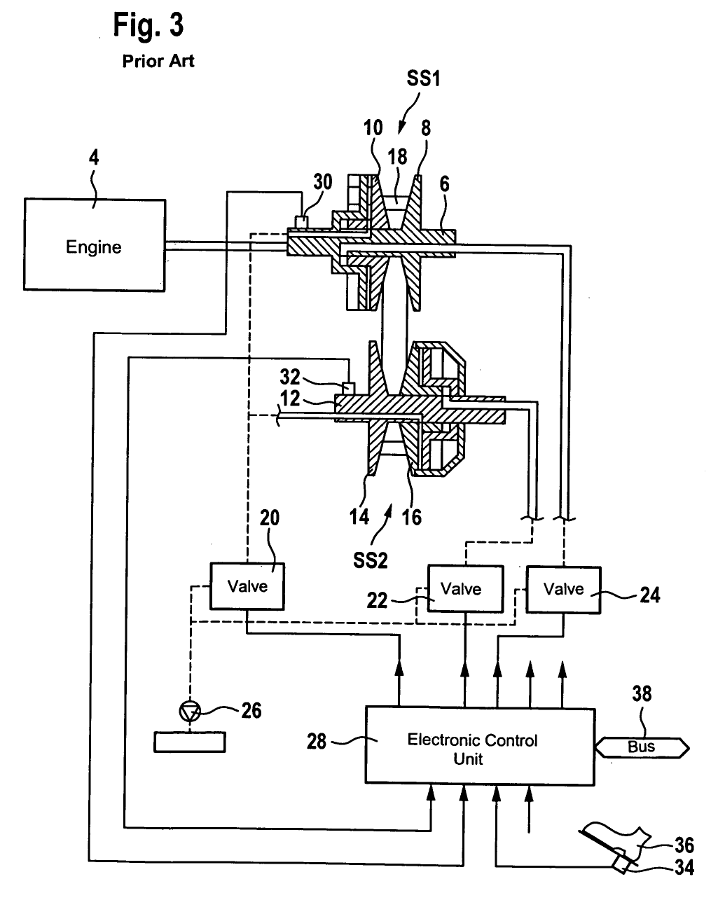

FIG. 1a shows a curve Nm which represents the rotational speed of an internal combustion engine that drives the drive shaft of the belt-driven conical-pulley transmission in accordance with FIG. 3, a curve Mm which indicates the torque of the internal combustion engine, and a curve Mmf which indicates the drive torque of the internal combustion engine filtered through a low pass filter, for example. The abscissa in each case represents time.

As can be seen in FIG. 1a, at time t₁ the load of the combustion engine suddenly increases, for example by the operation of a gas pedal.

It is useful to lower the slippage setting briefly when suddenly actuating the accelerator in that way, i.e., to increase the contact pressure somewhat. That can be helpful for example if the speed of the pressure build-up of the hydraulic system is limited, thereby creating a dynamic lead. That reduces the danger of unacceptably high slippage occurring or of transmission slipping.

The brief lowering of the slippage setting and the lowering of the actual slippage which follows lowering are explained in connection with by FIG. 1b.

Curve FP indicates the position of the gas pedal 36 to control the load of the internal combustion engine. It is clearly visible how the accelerator pedal is operated suddenly at time t₁.

Curve SS indicates the pattern of the slippage setting, which is calculated for example in accordance with the following formula:
SS=GS−d(Mmf/dt)*Factor,

where GS is a basic slippage,

d(Mmf/dt) is the time derivative of the filtered engine torque (shown in FIG. 1a), and

Factor stands for a proportionality value.

A basic slippage of 2.0 means, for example, that the actual difference between the rotational speeds of the two conical disk pairs varies from the difference resulting from the momentary theoretical transmission ratio by 2 min⁻¹.

Curve IS indicates the actual slippage IS measured in control unit 28 on the basis of the rotational speeds of the input shaft and output shaft of the transmission and a known process. Curve P indicates the contact pressure between the conical disks and the endless torque-transmitting means, controlled by control unit 28 with the help of the valve in FIG. 3. It is clearly visible how the contact pressure determined by a regulator contained in the control unit briefly increases significantly as the slippage setting SS decreases, and then decreases slowly so that the actual slippage follows the slippage setting.

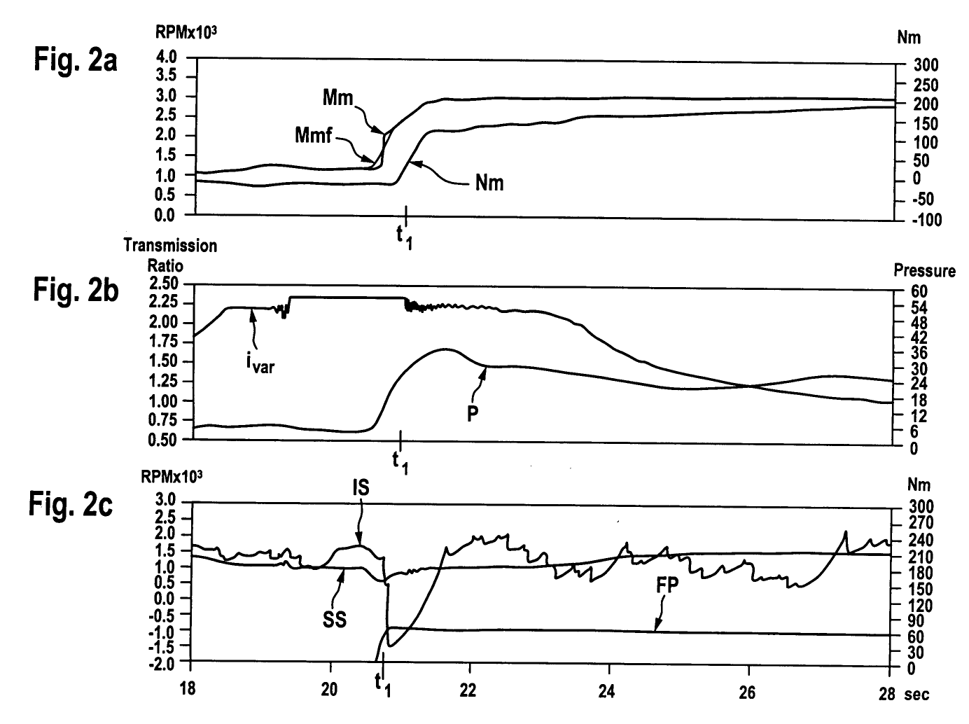

FIG. 2, in which the same designations are used for the individual curves as in FIG. 1, shows an example in which, when the transmission is working in underdrive, i.e., with the lowest possible transmission ratio, and at the same time the accelerator is activated, the slippage setting is intentionally reduced further in order to increase the contact pressure and thereby reduce the risk of slipping. FIG. 2b shows, in addition to contact pressure curve P, the transmission ratio iᵥₐᵣ. As can be seen, at time t₁ when the accelerator is suddenly activated, the transmission is at its lowest possible transmission ratio, so that the slippage setting SS is calculated in accordance with the following formula:
SS=GS−d(Mmf/dt)*Factor−f(iᵥₐᵣ),

where f(iᵥₐᵣ) is a function of the transmission ratio iᵥₐᵣ of the transmission, the value of which increases as the transmission ratio becomes lower. If the basic slippage is 2.0, for example, the value of f(iᵥₐᵣ) in underdrive can be 0.5, so that the value 0.5 is also deducted from the basic slippage. When the transmission is in overdrive, the slippage setting can be increased; that is, f(iᵥₐᵣ) can assume a negative value.

The invention described above in exemplary form can be augmented in many ways. For example, the speed of the vehicle can be taken into account when determining the slippage setting, by driving with low slippage at low speeds, for example when starting up under full load, in order to ensure absolutely reliable transmission of torque even when jerking occurs. Furthermore, for the same reasons the slippage setting can be reduced when decelerating. In addition, it is advantageous to increase the slippage setting at normal or moderate driving speeds and low to medium engine torque, so as to drive at the greatest possible efficiency with only slight excess contact pressure.

In dynamic situations, as when applying the accelerator as explained, or when detecting the activity of a vehicle stabilization system, the slippage setting can be reduced briefly in order to increase the security of the contact pressure. At the same time, depending upon the gradient of acceleration pedal activation, for example, a slippage offset from the previous slippage setting can be added, which necessarily is negative when the accelerator pedal gradient is positive.

Furthermore, from the contact pressure and the rotational speeds, as well as from the coefficients of friction, which are calculated from the friction loss given off during the frictional engagement, and the desired slippage setting, it can be determined in that way that a predetermined maximum friction loss is not exceeded, with allowance being made for its duration, and the value does not fall below a prescribed minimum friction loss, i.e., the transmission is operated with a minimum slippage and hence not with unnecessarily high contact pressure.

At very low engine speeds and very low driving speeds, i.e., at low speed operation, the slippage setting can be increased under load in order to suppress irregularities of the engine speed in the vehicle.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for determining a slippage setting between two components that transmit force through frictional engagement, one of which is driven by a drive unit and the other component is an output member for driving a driven unit, wherein a contact force that brings about the frictional connection between the components is variable, said method comprising the following steps:
determining at least one operating parameter of at least one of the drive unit and the driven unit, and
establishing a value for a slippage setting that corresponds to a desired slippage setting determined from a predetermined relationship between the at least one operating parameter and the slippage value.

2. A method in accordance with claim 1, including the step of reducing the slippage value setting when at least one of power delivered by the drive unit and a drive torque supplied by the drive unit is increased.

3. A method in accordance with claim 1, including the step of establishing the slippage value setting so that a predetermined maximum friction loss caused by slippage is not exceeded.

4. A method in accordance with claim 1, including the step of establishing the slippage value setting so that it does not fall below a minimum friction loss caused by the slippage.

5. A method in accordance with claim 1, wherein the driven component is an input-side disk pair of a belt-driven conical-pulley transmission contained in a power train of a motor vehicle and the other component is a disk pair on an output side of the transmission, and including the step of lowering the slippage value setting when a drive torque of the input-side disk pair is high and vehicle travel speed is low.

6. A method in accordance with claim 1, wherein the driven component is an input-side disk pair of a belt-driven conical-pulley transmission contained in a power train of a motor vehicle, and the other component is a disk pair on an output side of the transmission, and including the step of raising the slippage value setting in a medium speed region and low to medium drive torque.

7. A method in accordance with claim 1, wherein the driven component is an input-side disk pair of a belt-driven conical-pulley transmission contained in a power train of a motor vehicle, and the other component is a disk pair on an output side of the transmission, including the step of reducing the slippage value setting when operating parameters change suddenly as a result of at least one of a sudden actuation of an accelerator pedal and intervention of an electronic stability control system.

8. A method in accordance with claim 1, wherein the driven component is an input-side disk pair of a belt-driven conical-pulley transmission contained in a power train of a motor vehicle and the other component is a disk pair on an output side of the transmission, including the step of determining a slippage value setting SS in accordance with the following relationship:
SS=GS−d(Mmf/dt)*Factor−f(iᵥₐᵣ),
where
GS=a predetermined basic slippage value that is a function of vehicle operating parameters,
Mmf=filtered torque of an engine that drives the input-side disk pair,
Factor=a proportionality factor, and
F(iᵥₐᵣ)=the function of the transmission ratio iᵥₐᵣ.

9. A method in accordance with claim 1, including the steps of: ascertaining an actual slippage value, and changing contact forces that produce frictional engagement so that the difference between the slippage value setting and the actual slippage value decreases.

10. Apparatus for determining a slippage value setting between two components that transmit force through frictional engagement, one of which is driven by a drive unit and the other of which is an output member for driving a driven unit, said apparatus comprising:
a determination unit for determining at least one operating parameter of at least one of the drive unit and the driven unit;
a contact pressure unit for applying a variable contact force that produces frictional engagement of the two components; and
a slippage value setting determination unit to ascertain a slippage value setting as a function of the at least one operating parameter.

11. Apparatus in accordance with claim 10, wherein the slippage value setting determination unit contains a characteristic curve that specifies a slippage value setting that is a function of at least one operating parameter.

12. Apparatus in accordance with claim 10, including:
an actual slippage value determination unit for ascertaining an actual slippage value; and
a control unit for actuating the contact pressure unit so that a difference between the actual slippage value and the slippage value setting decreases.

13. A method in accordance with claim 1, wherein the driven unit is an input-side disk pair of a belt-driven conical-pulley transmission contained in a power train of a motor vehicle and the other component is a disk pair on an output side of the transmission, and including the step of lowering a desired slippage value during one of underdrive operation of the transmission and operation in an overrun mode.
